(19) United States
(12) Patent Application Publication
(10) Pub. No.: US 2026/0094876 A1
(43) Pub. Date: Apr. 2, 2026

(54) SECONDARY BATTERY AND METHOD FOR MANUFACTURING SAME

(71) Applicant: SAMSUNG SDI CO., LTD., Yongin-si (KR)

(72) Inventor: Taewoong JANG, Yongin-si (KR)

(21) Appl. No.: 19/064,942

(22) Filed: Feb. 27, 2025

(30) Foreign Application Priority Data
Oct. 2, 2024 (KR) 10-2024-0133947

(51) Int. Cl. H01M 10/0587; H01M 4/80; H01M 50/533; H01M 50/538

(52) U.S. Cl. CPC H01M 10/0587; H01M 4/80; H01M 50/533; H01M 50/538

(57) ABSTRACT

A secondary battery, including an electrode assembly having an electrode stacked body including a circular first electrode, a circular separator, and a circular second electrode in an alternating arrangement, and a first electrode tab connected to the first electrode, and a second electrode tab connected to the second electrode, an accommodation can accommodating the electrode assembly, the accommodation can electrically connected to the first electrode tab, a cap assembly sealing an opening of the accommodation can, the cap assembly electrically connected to the second electrode tab, and a first contact member between the electrode assembly and the first electrode tab.

### CROSS-REFERENCE TO RELATED APPLICATION

This application claims priority under 35 U.S.C § 119 to Korean Patent Application No. 10-2024-0133947, filed in the Korean Intellectual Property Office on Oct. 2, 2024, the entire contents of which are hereby incorporated by reference.

### BACKGROUND

### 1. Field

Embodiments relate to a secondary battery and a method for manufacturing a secondary battery.

### 2. Description of the Related Art

Recently, as the demand for wearable devices such as headphones, earphones, smart watches, and body-attached medical devices using Bluetooth increases, the demand for secondary batteries with a high energy density and a sufficiently small size is also increasing. Such a secondary battery is manufactured in a form that accommodates an electrode assembly in a circular can of which a height is significantly less than a width depending on characteristics of a usage environment and may be referred to as a coin cell or a button cell.

The above information disclosed in this Background section is for enhancement of understanding of the background of the present disclosure, and therefore, it may contain information that does not constitute related (or prior) art.

### SUMMARY

Embodiments are directed to a secondary battery, including an electrode assembly having an electrode stacked body including a circular first electrode, a circular separator, and a circular second electrode in an alternating arrangement, and a first electrode tab connected to the first electrode, and a second electrode tab connected to the second electrode, an accommodation can accommodating the electrode assembly, the accommodation can electrically connected to the first electrode tab, a cap assembly sealing an opening of the accommodation can, the cap assembly electrically connected to the second electrode tab, and a first contact member between the electrode assembly and the first electrode tab.

The first electrode may include a first string on and extending across an outer periphery of a circular base member of the first electrode, the first string dividing the circular base member of the first electrode into a first inner portion and a first outer portion, a first coated portion on the first inner portion, the first coated portion being coated with a first active material, and a first uncoated portion on the first outer portion, the first uncoated portion being not coated with the first active material, the second electrode may include a second string on and extending across an outer periphery of a circular base member of the second electrode, the second string dividing the circular base member of the second electrode into a second inner portion and a second outer portion, a second coated portion on the second inner portion, the second coated portion being coated with a second active material, and a second uncoated portion on the second outer portion, the second uncoated portion being not coated with the second active material.

An angle between a center of the circular base member of the first electrode and ends of the first string may be 30° to 60°, and an angle between a center of the circular base member of the second electrode and ends of the second string may be 30° to 60°.

An area of the first uncoated portion and an area of the second uncoated portion may each be, respectively, 0.4% to 2.9% of a total area of the circular base member of the first electrode and the circular base member of the second electrode.

A radius of the second electrode may be less than a radius of the first electrode, and the second electrode tab may include an insulating layer connected to one side of the second electrode in a region of the second electrode facing the first electrode.

The first electrode tab may be bent and between a lower surface of the electrode assembly and a bottom surface of the accommodation can, and the first contact member may be between the lower surface of the electrode assembly and the bent first electrode tab.

When the cap assembly and the accommodation can are coupled, the first electrode tab may be in close contact with one side surface inside the accommodation can.

The first contact member may include an elastic insulator.

The first contact member may include an elastic porous material.

The secondary battery may further include a second contact member between the electrode assembly and the second electrode tab.

The second electrode tab may be bent and between an upper surface of the electrode assembly and the cap assembly, and the second contact member may be between the upper surface of the electrode assembly and the bent second electrode tab.

When the cap assembly and the accommodation can are coupled, the second electrode tab may be in close contact with one side surface inside the cap assembly.

The second contact member may include an elastic insulator.

The second contact member may include an elastic porous material.

The cap assembly may include a terminal plate connected to the second electrode tab, a cap plate having a first opening portion joined to the opening of the accommodation can, and a cap insulating layer having a second opening portion and between the terminal plate and the cap plate insulating the terminal plate and the cap plate.

The terminal plate may include a body portion connected to the second electrode tab, and a protrusion extending upward from a center of the body portion and penetrating the first opening portion.

A diameter of the body portion may be greater than a diameter of an outer peripheral surface of the electrode assembly.

The secondary battery may further include an insulating member on a side surface inside the accommodation can corresponding to the second electrode tab.

Embodiments are directed to a method for manufacturing a secondary battery, the method including forming an electrode assembly by alternately stacking a circular first electrode, a circular separator, and a circular second electrode, disposing a first contact member on the electrode assembly, and bending and disposing a first electrode tab connected to the first electrode on the first contact member, accommodating the electrode assembly in an accommodation can with one opened side, and sealing the one opened side of the accommodation can with a cap assembly and connecting the first electrode tab and the accommodation can by a pressure transmitted from the cap assembly.

The forming of the electrode assembly may include forming a first electrode including a first coated portion formed on an inner side of a first string set on and extending across an outer periphery of a circular base member of the first electrode and coated with a first active material and a first uncoated portion on an outer side of the string not coated with the first active material, and forming a second electrode including a second coated portion formed on an inner side of a second string set on and extending across an outer periphery of a circular base member of the second electrode and coated with a second active material and a second uncoated portion formed on an outer side of the second string not coated the second active material.

### BRIEF DESCRIPTION OF THE DRAWINGS

Features will become apparent to those of skill in the art by describing in detail exemplary embodiments with reference to the attached drawings in which:

FIG. 1 is a perspective view illustrating a secondary battery according to one embodiment of the present disclosure.

FIG. 2 is an exploded perspective view of the secondary battery illustrated in FIG. 1.

FIG. 3 is a sectional view taken along A-A direction of the secondary battery illustrated in FIG. 1.

FIG. 4 is a diagram illustrating an example of an electrode assembly according to one embodiment of the present disclosure.

FIG. 5 is an exploded view of the electrode assembly viewed from above in a region B of FIG. 4.

FIG. 6 is a diagram illustrating an example of a first electrode plate and a second electrode plate according to one embodiment of the present disclosure.

FIG. 7 is a diagram of a first contact member and a second contact member coupled to an electrode assembly according to one embodiment of the present disclosure.

FIG. 8 is a sectional view of a terminal plate according to one embodiment of the present disclosure.

FIG. 9 is an exploded perspective view of a cap assembly according to one embodiment of the present disclosure.

FIG. 10 is a diagram illustrating a connection relationship between a cap assembly and an electrode assembly according to one embodiment of the present disclosure.

FIG. 11 is a diagram illustrating a connection relationship between an electrode assembly and an accommodation can according to one embodiment of the present disclosure.

FIG. 12 is a diagram illustrating a secondary battery according to another embodiment of the present disclosure.

FIG. 13 is a flowchart for describing a method for manufacturing a secondary battery according to one embodiment of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

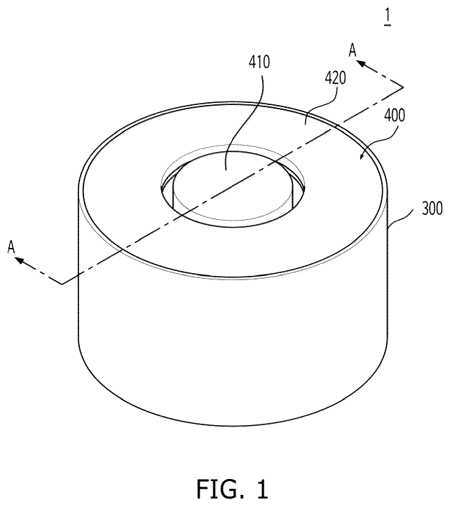

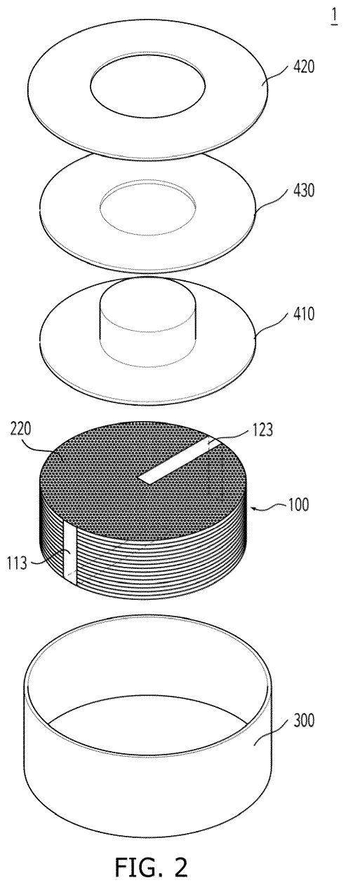

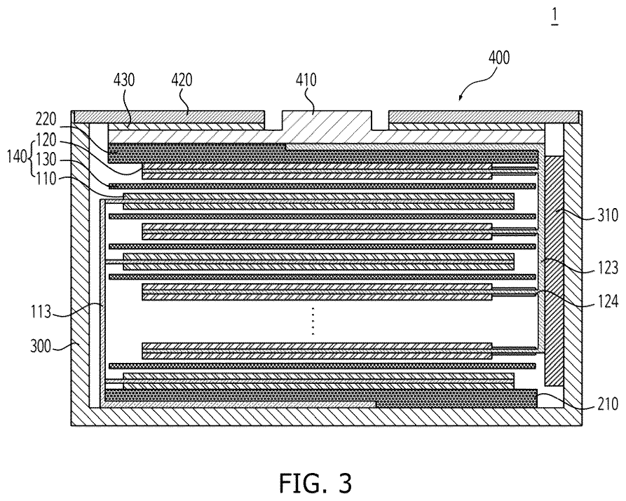

FIG. 1 is a perspective view illustrating a secondary battery according to one embodiment of the present disclosure. FIG. 2 is an exploded perspective view of the secondary battery illustrated in FIG. 1. FIG. 3 is a sectional view taken along A-A direction of the secondary battery illustrated in FIG. 1.

A secondary battery according to one or more embodiments may be a micro-sized secondary battery and may be a coin cell or a button cell. In an implementation the secondary battery may be a cylindrical or pin-type battery.

The coin cell or button cell may be a battery in the form of a thin coin or button and may refer to a battery having a ratio of height to diameter (height/diameter) of 1 or less. Because the coin cell or button cell may be generally cylindrical, the cross section in the horizontal direction may be generally circular. However, the cross section in the horizontal direction may have an elliptical or polygonal shape. The diameter may refer to a maximum distance in the horizontal direction of the battery, and the height may refer to a maximum distance in the vertical direction of the battery (e.g., distance from the flat bottom surface to the flat top surface of the battery).

Referring to FIGS. 1 to 3, a secondary battery 1 according to one embodiment of the present disclosure may include, e.g., an electrode assembly 100, a first contact member 210 on one side of the electrode assembly 100, a second contact member 220 on the other side of the electrode assembly 100, an accommodation can 300 that may accommodate the electrode assembly 100 inserted through an opened side, the first contact member 210, and the second contact member 220, and a cap assembly 400 sealing the opened side of the accommodation can 300. The accommodation can 300 may be, e.g., a battery case.

According to one embodiment, the electrode assembly 100 may include electrode stacked bodies 140, each formed by alternately stacking, e.g., a circular first electrode 110, a circular separator 130, and a circular second electrode 120, first electrode tabs 113 connected to the first electrodes 110, and second electrode tabs 123 connected to the second electrodes 120. The electrode stacked body 140 may be a stacked structure formed by alternately stacking a plurality of first electrodes 110, separators 130, and second electrodes 120. For example, the electrode stacked body 140 may include, e.g., a circular first electrode 110, a circular separator 130, and a circular second electrode 120 in an alternating arrangement. In one embodiment, the first electrode 110 may be a negative electrode, and the second electrode 120 may be a positive electrode. In an implementation, the first electrode 110 may be a positive electrode, and the second electrode 120 may be a negative electrode.

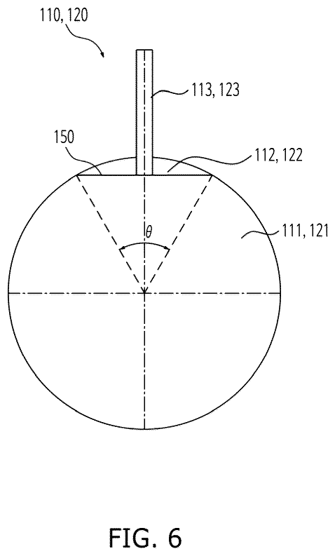

According to one embodiment, the first electrode 110 may include, e.g., a first coated portion 111 (see FIG. 6) in a region where a first active material may be applied to both surfaces of a first base member made of a circular thin metal plate, and a first uncoated portion 112 (see FIG. 6) in a region where the first active material may not be applied and the base member may therefore be exposed. The first coated portion 111 may include a first active material, e.g., graphite or carbon, coated on a circular current collector plate made of a metal foil, e.g., copper, a copper alloy, nickel, or a nickel alloy. The first uncoated portion 112 may be a region where the first active material is not applied. The first uncoated portion 112 may be connected to a separately formed first electrode tab 113, or a part of the first uncoated portion 112 may be punched out to form the first electrode tab 113. The first electrode 110 or the first electrode tab 113 may be connected to the accommodation can 300. The accommodation can 300 connected to the first electrode 110 may function as a negative electrode.

According to one embodiment, the second electrode 120 may include, e.g., a second coated portion 121 (see FIG. 6) in a region where a second active material may be applied to both surfaces of a second base member made of a circular thin metal plate, and a second uncoated portion 122 (see FIG. 6) in a region where the first active material may not be applied and the base member may therefore be exposed. The second coated portion 121 may be formed by applying the second active material such as a transition metal oxide to a current collector plate made of a metal foil such as aluminum or an aluminum alloy. The second uncoated portion 122, which may be a region where the second active material may not be applied, may be connected to the separately formed second electrode tab 123, or a part of the second uncoated portion 122 may be punched out to form the second electrode tab 123. The second electrode 120 may be connected to the cap assembly 400. The cap assembly 400 connected to the second electrode 120 may function as a positive electrode.

According to one embodiment, the separator 130 may be between the first electrode 110 and the second electrode 120. The separator 130 may insulate the first electrode 110 and the second electrode 120, e.g., the separator 130 may help insulate the first electrode 110 and the second electrode 120 from each other and may help exchange lithium ions between the first electrode 110 and the second electrode 120. Even if the electrode assembly 100 shrinks or expands in a procedure of charging and discharging the secondary battery 1, the separator 130 may have a sufficient length to completely insulate the first electrode 110 and the second electrode 120.

According to one embodiment, the first electrode tab 113 may be connected to the first electrode 110. The first electrode tab 113 may be connected to the first uncoated portion 112 of the first electrode 110, or the first electrode tab 113 may be formed by punching out the first uncoated portion 112. The first electrode tab 113 may include the same material as a metal base member of the first electrode 110. The plurality of first electrode tabs 113 connected to the first uncoated portions 112 may be formed in the same direction and may face each other. The plurality of first electrode tabs 113 may be connected to each other by welding. In an implementation, one tab may be formed by connecting the plurality of first electrode tabs 113 by welding. In an implementation, the plurality of first electrode tabs 113 may be connected to a lead tab by welding such that the first electrode tabs are bent to be connected to the accommodation can 300.

According to one embodiment, the first electrode tab 113 connected to the first electrode 110 may be electrically connected to the accommodation can 300. The first electrode tab 113 may function as a current path of the accommodation can 300 connected to the first electrode 110. In an implementation, the first electrode tab 113 may be bent so as to face a bottom surface of the accommodation can 300 and may be bent again so as to be between a lower surface of the electrode assembly 100 and the bottom surface of the accommodation can 300. The first electrode tab 113 may be between the electrode assembly 100 and one side surface inside the accommodation can 300. The first electrode tab 113 may be between the lower surface of the electrode assembly 100 and an inner bottom surface of the accommodation can 300 and may be closely connected to the accommodation can 300 by a pressure applied by the electrode assembly 100. In one embodiment, the first electrode tab 113 may be electrically connected to the inner bottom surface of the accommodation can 300 by the pressure applied by the electrode assembly 100 without a separate joining process, e.g., welding.

According to one embodiment, the first contact member 210 may be between the first electrode tab 113 and the lower surface of the electrode assembly 100. In one embodiment, the first electrode tab 113 may be on a lower surface of the first contact member 210. The first electrode tab 113 may be on the lower surface of the first contact member 210 and may be closely connected to the accommodation can 300 by a pressure applied by the first contact member 210. In an implementation, the first electrode tab 113 may be electrically connected to the inner bottom surface of the accommodation can 300 by the pressure applied by the first contact member 210 without a separate joining process, e.g., welding.

According to one embodiment, the second electrode tab 123 may be connected to the second electrode 120. The second electrode tab 123 may be connected to the second uncoated portion 122 of the second electrode 120 or may be formed by punching out the second uncoated portion 122. The second electrode tab 123 may include the same material as a metal base member of the second electrode 120. The plurality of second electrode tabs 123 connected to the second uncoated portions 122 may be formed in the same direction and facing each other. The plurality of second electrode tabs 123 may be connected to each other by welding. For example, one tab may be formed by connecting the plurality of second electrode tabs 123 by welding. As another example, the plurality of second electrode tabs 123 may be connected to a second lead tab by welding such that the second electrode tabs are bent to be connected to the cap assembly 400.

According to one embodiment, the second electrode tab 123 connected to the second electrode 120 may be electrically connected to the cap assembly 400. The first electrode tab 113 may function as a current path of the accommodation can 300 connected to the first electrode 110. In an implementation, the second electrode tab 123 may be bent so as to face one side surface inside the cap assembly 400 and may be bent again so as to be between an upper surface of the electrode assembly 100 and one side surface inside the cap assembly 400. The second electrode tab 123 may be connected to the cap assembly 400. The second electrode tab 123 may be on an upper surface of the second contact member 220. The second electrode tab 123 may be between the electrode assembly 100 and one side surface inside the cap assembly 400. The second electrode tab 123 may be between the electrode assembly 100 and one side surface inside the cap assembly 400, and may be closely connected, e.g., directly connected, to the cap assembly 400 by the pressure applied by the electrode assembly 100. In one embodiment, the second electrode tab 123 may be electrically connected to one side surface inside the cap assembly 400 by the pressure applied by the electrode assembly 100 without a separate joining process, e.g., welding.

According to one embodiment, the second contact member 220 may be between the second electrode tab 123 and the upper surface of the electrode assembly 100. In one embodiment, the second electrode tab 123 may be on the upper surface of the second contact member 220. The second electrode tab 123 may be on the upper surface of the second contact member 220 and may be closely connected to the cap assembly 400 by the pressure applied by the second contact member 220. In an implementation, the second electrode tab 123 may be electrically connected to one side surface inside the cap assembly 400 by the pressure applied by the second contact member 220 without a separate joining process, e.g., welding.

According to one embodiment, the second electrode tab 123 may be connected to one side of the second electrode 120 and may include, e.g., an insulating layer 124 in one region of the second electrode 120 facing the first electrode 110. In an implementation, the separator 130 may be between the first electrode 110 and the second electrode 120, there may be a problem in that a short circuit may occur between the first electrode 110 and the second electrode 120 because an area of the first electrode 110 may be greater than an area of the second electrode 120. A short circuit with the first electrode 110 to which the second electrode tab faces in a procedure of bending the second electrode tab 123 extending to be connected from one side of the second electrode 120 may occur. To prevent this, the second electrode tab 123 may include the insulating layer 124 in a region connected to the second electrode 120.

According to one embodiment, the first contact member 210 may be between the electrode assembly 100 and the accommodation can 300. The first contact member 210 may be on the lower surface of the electrode assembly 100 in relation to a direction in which the electrode assembly 100 is stacked. In such a configuration, the first contact member 210 may bring the first electrode tab 113 and the accommodation can 300 into close contact, e.g., direct contact, with each other. The first contact member 210 may be pressed between the electrode assembly 100 and the accommodation can 300 by a pressure transmitted from the cap assembly 400, and thus, the first electrode tab 113 and the accommodation can 300 may be brought into close contact with each other.

According to one embodiment, the first contact member 210 may include an elastic insulator. In an implementation, the first contact member 210 may be an elastic body that may be pressed by the pressure transmitted from the cap assembly 400. The first contact member 210 may be an insulator that prevents a short circuit from occurring between another component of the electrode assembly 100 other than the first electrode 110 and the accommodation can 300. The first contact member 210 may include an elastic insulator, e.g., rubber, silicone, or polymer.

According to one embodiment, the first contact member 210 may include an elastic porous material. The first contact member 210 may be a porous material that may be pressed to bring the first electrode tab 113 and the accommodation can 300 into close contact with each other while containing an electrolyte. The first contact member 210 may be a porous material having, e.g., a sponge structure, a honeycomb structure, or pores of various shapes.

In one embodiment, the second contact member 220 may be between the electrode assembly 100 and the cap assembly 400. The second contact member 220 may be on the upper surface of the electrode assembly 100 in relation to the direction in which the electrode assembly 100 is stacked. In such a configuration, the second contact member 220 may bring the second electrode tab 123 and the cap assembly 400 into close contact with each other. The second contact member 220 may be pressed between the cap assembly 400 and the electrode assembly 100 by the pressure transmitted from the electrode assembly 100 or the cap assembly 400, and thus, the second electrode tab 123 and the cap assembly 400 are brought into close contact with each other.

In one embodiment, the second contact member 220 may include an elastic insulator. The second contact member 220 may be an elastic body that may be pressed by the pressure transmitted from the electrode assembly 100 or the cap assembly 400. The second contact member 220 may be an insulator that prevents a short circuit from occurring between another component of the electrode assembly 100 other than the second electrode 120 and the cap assembly 400. The second contact member 220 may include an elastic insulator, e.g., rubber, silicone, or polymer.

In one embodiment, the second contact member 220 may include an elastic porous material. The second contact member 220 may be a porous material that may be pressed to bring the second electrode tab 123 and the cap assembly 400 into close contact with each other while containing an electrolyte. The second contact member 220 may be a porous material having a sponge structure, e.g., a honeycomb structure, or pores of various shapes.

According to one embodiment, the accommodation can 300 may have one side opened to accommodate the electrode assembly 100 and may be electrically connected to the first electrode 110. The accommodation can 300 may be connected to the first electrode 110 through the first electrode tab 113 and may function as a negative electrode.

According to one embodiment, the accommodation can 300 may form an overall exterior of the secondary battery 1. In an implementation, the accommodation can 300 may have a cylindrical shape with one opened side. The accommodation can 300 may include a circular lower surface and a side wall extending vertically from a circumference of the lower surface. The accommodation can 300 may be formed such that a diameter of the lower surface is greater than a height of the side wall, and thus, the secondary battery 1 may include a button cell or a coin cell.

According to one embodiment, an upper surface opposite to the lower surface of the accommodation can 300 may be opened, e.g., may include an opening, to expose an accommodation space capable of accommodating the electrode assembly 100. After the electrode assembly 100 is accommodated in the accommodation can 300, the electrode assembly 100 may be sealed by covering one opened side of the accommodation can 300 with the cap assembly 400. In an implementation, an upper surface of the side wall of the accommodation can 300 may have a stepped portion from an outside to an inside. The cap assembly 400 may be coupled by metal bonding (e.g., welding, brazing, soldering, or the like) so as to be interlocked with the stepped portion of the accommodation can 300.

According to one embodiment, an insulating member 310 may be on a side surface inside the accommodation can 300 so as to correspond to the second electrode tab 123. In order to prevent a short circuit between the accommodation can 300 connected to the first electrode tab 113 and the second electrode tab 123, the insulating member 310 may be on the side surface inside the accommodation can 300 so as to correspond to an area of the second electrode tab 123. In an implementation, the insulating member 310 may be an insulating tape made of a polymer material.

In one embodiment, the cap assembly 400 may seal the one opened side of the accommodation can 300. The cap assembly 400 may seal the electrode assembly 100 from the outside by covering one opened side of the accommodation can 300. The cap assembly 400 may be electrically connected to the second electrode 120. The cap assembly 400 may function as a positive electrode by being connected to the second electrode 120 through the second electrode tab 123.

According to one embodiment, the cap assembly 400 may include, e.g., a terminal plate 410, a cap plate 420, and a cap insulating layer 430.

According to one embodiment, the terminal plate 410 may be connected to the second electrode 120. The terminal plate 410 may be on the second contact member 220. The second electrode tab 123 may be between the terminal plate 410 and the second contact member 220. The terminal plate 410 may be electrically connected to the second electrode 120 through the second electrode tab 123.

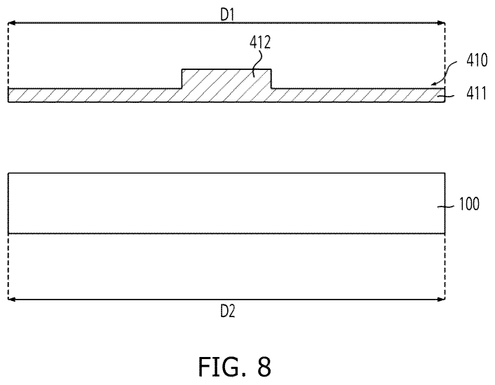

According to one embodiment, the cap insulating layer 430 and the cap plate 420 may be sequentially on the terminal plate 410. The terminal plate 410 may have a protrusion 412 (see FIG. 8) protruding, e.g., extending, upward from a center region. The protrusion 412 may penetrate a first opening portion of the cap plate 420 and a second opening portion of the cap insulating layer 430 to protrude outward.

In one embodiment, the cap plate 420 may be joined to one opened side of the accommodation can 300. The cap plate 420 may be mounted on an outer wall of the accommodation can 300 and may be joined to the accommodation can 300. The cap plate 420 may be on the cap insulating layer 430.

According to one embodiment, the cap plate 420 may include the first opening portion. The cap plate 420 may have a disk shape including the first opening portion as a center, e.g., the opening may be at a center position of the cap plate 420. The protrusion 412 of the terminal plate 410 may penetrate the first opening portion to be connected to an external terminal.

According to one embodiment, the cap insulating layer 430 may be on the terminal plate 410. The cap insulating layer 430 may be between the terminal plate 410 and the cap plate 420 to insulate the terminal plate 410 and the cap plate 420. Because the terminal plate 410 may be connected to the second electrode 120 and the cap plate 420 may come into contact with the accommodation can 300 connected to the first electrode 110, the cap insulating layer 430 may be between the terminal plate 410 and the cap plate 420 to insulate the terminal plate 410 and the cap plate 420.

According to one embodiment, the cap insulating layer 430 may have the second opening portion. The cap insulating layer 430 may have a disk shape with the second opening portion as a center. The protrusion 412 of the terminal plate 410 may penetrate the second opening portion to be connected to an external terminal.

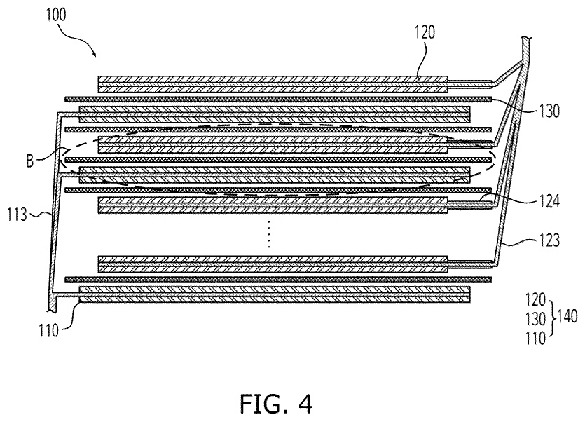

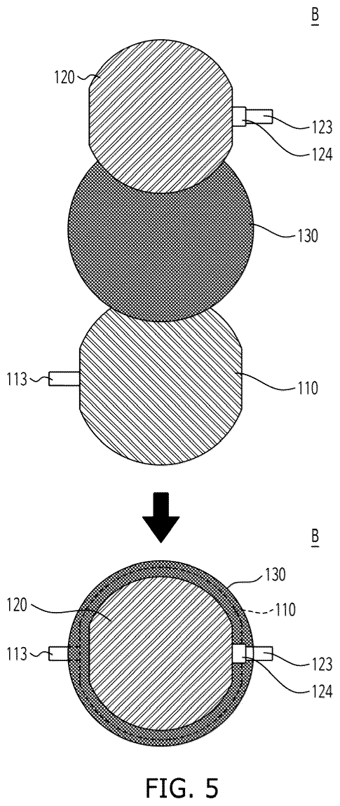

FIG. 4 is a diagram illustrating an example of an electrode assembly according to one embodiment of the present disclosure. FIG. 5 is an exploded view of the electrode assembly viewed from above in a region B of FIG. 4.

Referring to FIGS. 4 and 5, an electrode stacked body 140 according to one embodiment of the present disclosure may be formed by alternately stacking a plurality of first electrodes 110, separators 130, and second electrodes 120.

According to one embodiment, a first electrode tab 113 may be connected to one side of each of the plurality of first electrodes 110. In an implementation, the first electrode tab 113 may be formed by connecting a strip-shaped metal base member to each of first uncoated portions 112 of the plurality of stacked first electrodes 110. As another example, each of the first uncoated portions 112 may be formed by punching out a strip shape to form a first electrode tab 113. The first electrode tab 113 may include the same material as a metal base member of the first electrode 110.

According to one embodiment, the plurality of first electrode tabs 113 connected to the first uncoated portions 112 may be formed in the same direction and facing each other. The plurality of first electrode tabs 113 may be connected to each other by welding. In an implementation, one tab may be formed by connecting the plurality of first electrode tabs 113 by welding. As another example, the plurality of first electrode tabs 113 may be connected to a first lead tab by welding such that the first electrode tabs are bent to be connected to an accommodation can 300.

According to one embodiment, a second electrode tab 123 may be connected to one side of each of the plurality of second electrodes 120. The second electrode tab 123 may be connected to the second electrode 120 in a direction opposite to a direction in which the first electrode tab 113 is formed. In an implementation, the second electrode tab 123 may be formed by connecting a strip-shaped metal base member to each of second uncoated portions 122 of the plurality of stacked second electrodes 120. As another example, each of the second uncoated portion 122 may be formed by punching out a strip shape to form a second electrode tab 123. The second electrode tab 123 may include the same material as a metal base member of the second electrode 120.

According to one embodiment, the plurality of second electrode tabs 123 connected to the second uncoated portions 122 may be formed in the same direction and facing each other. The plurality of second electrode tabs 123 may be connected to each other by welding. In an implementation, one tab may be formed by connecting the plurality of second electrode tabs 123 by welding. As another example, the plurality of second electrode tabs 123 may be connected to a second lead tab by welding such that the second electrode tabs are bent to be connected to the cap assembly 400.

According to one embodiment, the first electrode 110, the separator 130, and the second electrode 120 may be formed in a circular shape to correspond to an accommodation space of the accommodation can 300 (see FIG. 2). The first electrode 110 may function as a negative electrode, and the second electrode 120 may function as a negative electrode. Thus, an area of the first electrode 110 may be formed to be greater than an area of the second electrode 120. In an implementation, a radius of the second electrode 120 may be formed to be less than a radius of the first electrode 110. In an implementation, the radius of the first electrode 110 may be formed to be less than the radius of the second electrode 120. In order to prevent a short circuit from occurring between the first electrode 110 and the second electrode 120, an area of the separator 130 between the first electrode 110 and the second electrode 120 may be formed to be greater than the area of either the first electrode 110 or the second electrode 120.

According to one embodiment, although the separator 130 may be between the first electrode 110 and the second electrode 120, because the area of the first electrode 110 is greater than the area of the second electrode 120, a short circuit may occur between the first electrode 110 and the second electrode 120. Therefore, to prevent this, an insulating layer 124 may be on one region of the second electrode 120 facing the first electrode 110.

FIG. 6 is a diagram illustrating an example of a first electrode plate and a second electrode plate according to one embodiment of the present disclosure.

Referring to FIG. 6, according to one embodiment of the present disclosure, a first electrode 110 may include a first coated portion 111 and a first uncoated portion 112. The first coated portion 111 may be a region where a first active material is coated on an inner side of a string 150 set on an outer periphery of a circular base member of the first electrode 110. The first uncoated portion 112 may be a region where the first active material is not coated on an outer side of the string 150 set on the outer periphery of the circular base member of the first electrode 110. For example, as shown in FIG. 6, the string 150 may extend across an outer periphery of the circular surface of the circular base member of the first electrode 110 and divide the circular base member of the first electrode 110 into two portions which may be called, respectively, an inner portion and an outer portion. The first coated portion 111 may correspond with the inner portion of the first electrode 110 and the first uncoated portion 112 may correspond with the outer portion.

According to one embodiment, a second electrode 120 may include a second coated portion 121 and a second uncoated portion 122. The second coated portion 121 may be a region where a second active material is coated on an inner side of on a string 150 set on an outer periphery of a circular base member of the second electrode 120. The second uncoated portion 122 may be a region where the second active material is not coated on an outer side of the string 150 set on the outer periphery of the circular base member of the second electrode 120. For example, as shown in FIG. 6, the string 150 may extend across an outer periphery of the circular surface of the second electrode 120 and divide the second electrode 120 into an inner portion and an outer portion. The second coated portion 121 may correspond with the inner portion of the second electrode 120 and the second uncoated portion 122 may correspond with the outer portion.

According to one embodiment, the string 150 on the circular base member of the first electrode 110 and the string 150 on the circular base member of the second electrode 120 may be set such that an angle θ between a center of each of the circular base members and the ends of each of the strings 150 is, respectively, 30° to 60°.

According to one embodiment, when the angle between the center of the circular base member of the first electrode 110 and the circular base member of the second electrode 120 and the ends of each of the strings 150 is, respectively, e.g., 30° to 60°, the first uncoated portion 112 and the second uncoated portion 122 may be formed in a range of 0.4% to 2.9% of a total area of the circular base member of the first electrode 110 and the circular base member of the second electrode 120, respectively. This is to ensure that the first electrode tab 113 and the second electrode tab 123 are formed in opposite directions and each of the first electrode tab 113 and the second electrode tab 123 may be stably connected to the first uncoated portion 112 and the second uncoated portion 122 by welding and the active material may be sufficiently applied. The above-described range of the angle is a description of one particular implementation.

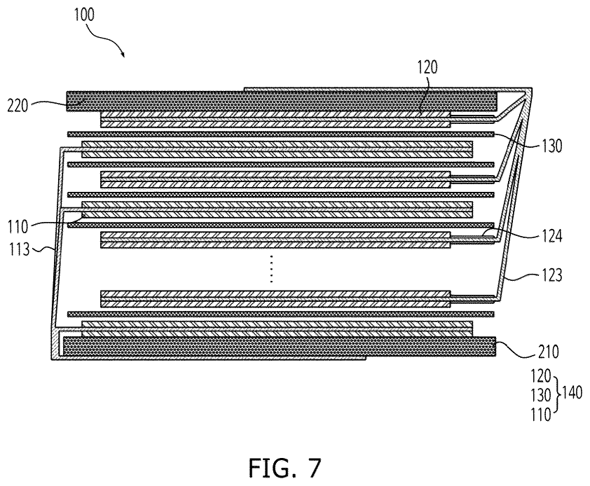

FIG. 7 is a diagram of a first contact member and a second contact member coupled to an electrode assembly according to one embodiment of the present disclosure.

Referring to FIG. 7, according to one embodiment of the present disclosure, a first contact member 210 may be on a lower surface of an electrode assembly 100 based on a direction in which the electrode assembly 100 is stacked. A first electrode tab 113 may be bent so as to be on a lower surface of the first contact member 210. The first contact member 210 may be between the bent first electrode tab 113 and the lower surface of the electrode assembly 100.

According to one embodiment, a second contact member 220 may be on an upper surface of the electrode assembly 100 in relation to a direction in which the electrode assembly 100 is stacked. A second electrode tab 123 may be bent so as to be on an upper surface of the second contact member 220. The first contact member 210 may be between the bent second electrode tab 123 and the upper surface of the electrode assembly 100.

FIG. 8 is a sectional view of a terminal plate according to one embodiment of the present disclosure.

Referring to FIG. 8, according to one embodiment, a terminal plate 410 may include, e.g., a body portion 411 connected to a second electrode 120 and a protrusion 412 protruding, e.g., extending, upward from a center of the body portion 411.

According to one embodiment, the body portion 411 may have a shape corresponding to one surface of the facing electrode assembly 100. A diameter D1 of the body portion 411 may be greater than or equal to a diameter D2 of the electrode assembly 100.

In a procedure of sealing a cap assembly 400 in the accommodation can 300, the diameter D1 of the body portion 411 may be greater than or equal to the diameter D2 of the electrode assembly 100 such that the cap assembly 400 applies a pressure downward such that the first contact member 210 and the second contact member 220 are sufficiently pressed.

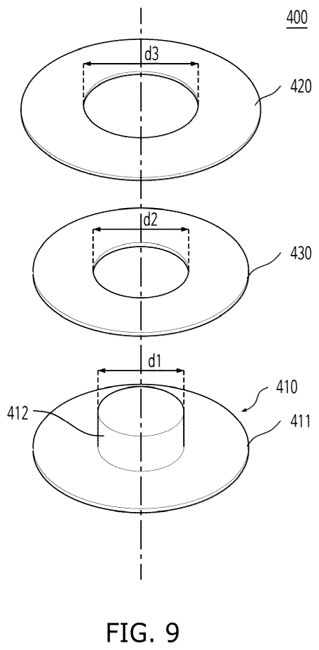

FIG. 9 is an exploded perspective view of a cap assembly according to one embodiment of the present disclosure.

Referring to FIG. 9, according to one embodiment, a protrusion 412 of a terminal plate 410 may be formed to protrude upward from a center of a body portion 411. The protrusion 412 may penetrate a first opening portion of a cap plate 420.

According to one embodiment, a diameter d1 of the protrusion 412 of the terminal plate 410 may be less than an inner diameter d3 of the first opening portion of the cap plate 420 and an inner diameter d2 of a second opening portion of a cap insulating layer 430. In order for the protrusion 412 to penetrate the first opening portion and the second opening portion and be connected to an external terminal, the diameter d1 of the protrusion 412 of the terminal plate 410 may be less than an inner diameter d3 of the first opening portion and the inner diameter d2 of the second opening portion.

According to one embodiment, the inner diameter d2 of the second opening portion of the cap insulating layer 430 may be less than the inner diameter d3 of the first opening portion of the cap plate 420. Through this configuration, it may be possible to prevent the protrusion 412 of the terminal plate 410 from coming into contact with the first opening portion of the cap plate 420.

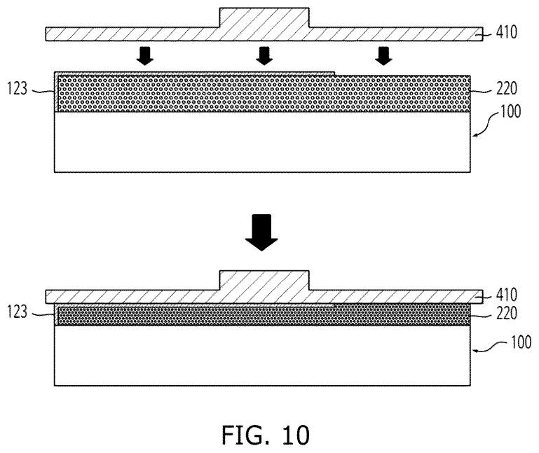

FIG. 10 is a diagram illustrating a connection relationship between a cap assembly and an electrode assembly according to one embodiment of the present disclosure.

Referring to FIG. 10, according to one embodiment, a second contact member 220 may be on an upper part of an electrode assembly 100. A second electrode tab 123 may be bent and on the second contact member 220. A cap assembly 400 may seal an accommodation can 300, and a terminal plate 410 may be on the second contact member 220. The second electrode tab 123 may be between the second contact member 220 and the terminal plate 410. According to this configuration, the terminal plate 410 may be electrically connected to a second electrode 120 through the second electrode tab 123 without a separate process, e.g., welding.

In one embodiment, in a procedure of sealing the accommodation can 300, the cap assembly 400 may apply a pressure to the second contact member 220 and the electrode assembly 100. The second contact member 220 may be pressed between the cap assembly 400 and the electrode assembly 100 by the pressure transmitted from the cap assembly 400. As the second contact member 220 is pressed, the second electrode tab 123 may be bought into contact with one side surface inside the cap assembly 400.

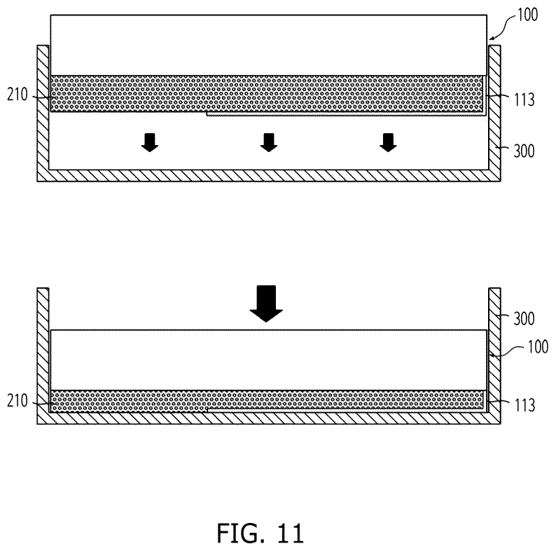

FIG. 11 is a diagram illustrating a connection relationship between an electrode assembly and an accommodation can according to one embodiment of the present disclosure.

Referring to FIG. 11, according to one embodiment, a first contact member 210 may be under an electrode assembly 100. A first electrode tab 113 may be bent and under the first contact member 210. When the electrode assembly 100 is accommodated in an accommodation can 300, the first electrode tab 113 may be between the first contact member 210 and the accommodation can 300. According to this configuration, the accommodation can 300 may be electrically connected to a first electrode 110 through the first electrode tab 113 without a separate process such as welding.

In one embodiment, in a procedure of sealing the accommodation can 300, a cap assembly 400 may apply a pressure to the first contact member 210 and the electrode assembly 100. The first contact member 210 may be pressed between the electrode assembly 100 and the accommodation can 300 by the pressure transmitted from the cap assembly 400. As the first contact member 210 is pressed, the first electrode tab 113 may be brought into close contact with one side surface inside the accommodation can 300.

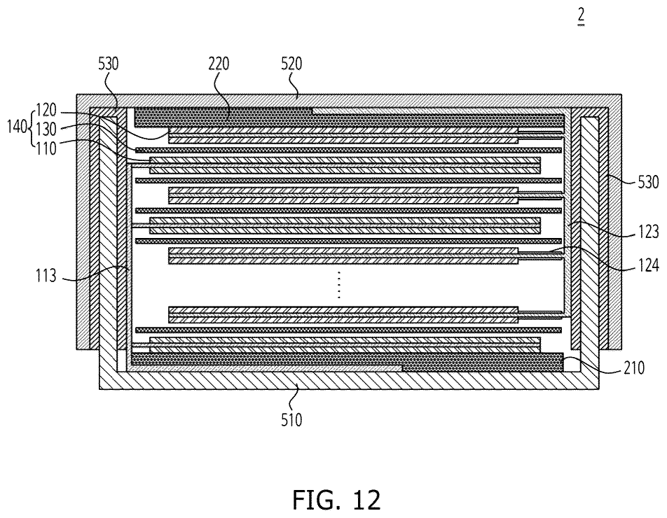

FIG. 12 is a diagram illustrating a secondary battery according to another embodiment of the present disclosure.

Referring to FIG. 12, a secondary battery 2 according to another embodiment of the present disclosure may include an electrode assembly 100, a lower can 510, an upper can 520, and a can gasket 530.

According to one embodiment, the electrode assembly 100 may include electrode stacked bodies 140 each formed by alternately stacking a circular first electrode 110, a circular separator 130, and a circular second electrode 120, first electrode tabs 113 connected to the first electrodes 110, and second electrode tabs 123 connected to the second electrodes 120.

According to one embodiment, the electrode stacked body 140 may be formed by alternately stacking a plurality of first electrodes 110, separators 130, and second electrodes 120. In one embodiment, the first electrode 110 may be a negative electrode, and the second electrode 120 may be a positive electrode. For example, the first electrode may be a positive electrode, and the second electrode may be a negative electrode.

According to one embodiment, the first electrode tab 113 may be connected to the first electrode 110. The first electrode tab 113 connected to the first electrode 110 may be electrically connected to the lower can 510. The first electrode tab 113 may function as a current path of the lower can 510 connected to the first electrode 110.

According to one embodiment, the second electrode tab 123 may be connected to the second electrode 120. The second electrode tab 123 connected to the second electrode 120 may be electrically connected to the upper can 520. The second electrode tab 123 may function as a current path for the upper can 520 connected to the second electrode 120.

According to one embodiment, a first contact member 210 may be between the electrode assembly 100 and the lower can 510. The first contact member 210 may be on the lower surface of the electrode assembly 100 in relation to a direction in which the electrode assembly 100 is stacked.

In one embodiment, a second contact member 220 may be between the electrode assembly 100 and the upper can 520. The second contact member 220 may be on the upper surface of the electrode assembly 100 in relation to the direction in which the electrode assembly 100 is stacked.

The electrode assembly 100, the first contact member 210, and the second contact member 220 illustrated in FIG. 12 may have substantially the same structure as the electrode assembly 100, the first contact member 210, and the second contact member 220 described above in FIGS. 1 to 3, and thus, a detailed description thereof is omitted below.

According to one embodiment, the lower can 510 may have one opened side, e.g., an opening, to accommodate the electrode assembly 100 and may be electrically connected to the first electrode 110. The lower can 510 may be connected to the first electrode tab 113. The lower can 510 may be connected to the first electrode 110 through the first electrode tab 113 and may function as a negative electrode.

In one embodiment, the upper can 520 may seal the one opened side of the lower can 510. The upper can 520 may cover the one opened side of the lower can 510 to seal the electrode assembly 100 from an outside. The upper can 520 may be electrically connected to the second electrode 120. The upper can 520 may function as a positive electrode by being connected to the second electrode 120 through the second electrode tab 123.

In one embodiment, the can gasket 530 may surround an inner surface and an outer surface of the lower can 510. The can gasket 530 may be between the lower can 510 and the upper can 520 to help insulate the lower can 510 and the upper can 520. Because the lower can 510 may be connected to the first electrode 110 and the upper can 520 may be connected to the second electrode 120, the can gasket 530 may be between the lower can 510 and the upper can 520 and insulate the lower can 510 and the upper can 520.

In an implementation, the can gasket 530 may be made of a polymer including, e.g., ethylene propylene rubber (EPDM), polypropylene (PP), polyimide (PI), polyethylene terephthalate (PET), polycarbonate (PC), or a combination thereof. In an implementation, the can gasket 530 may be made of a ceramic material including, e.g., epoxy resin, alumina (Al2O3), zirconia (ZrO2), aramid fiber, Nomex, or a combination thereof. The material of the can gasket 530 may include any material with excellent plasticity and insulating properties.

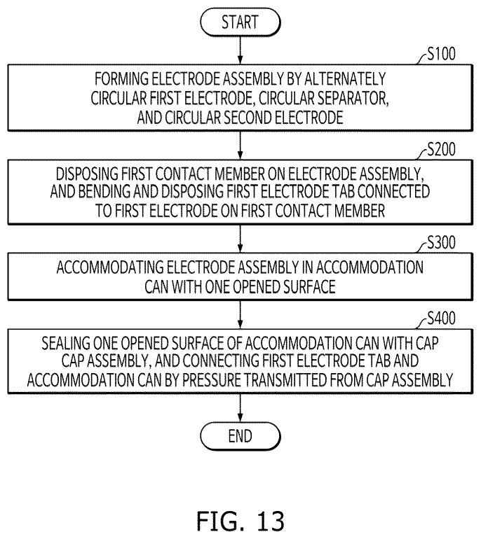

FIG. 13 is a flowchart for describing a method for manufacturing a secondary battery according to one embodiment of the present disclosure.

Referring to FIGS. 3 and 13, the method for manufacturing a secondary battery according to one embodiment of the present disclosure may include step S100 of forming an electrode assembly by alternately stacking a circular first electrode, a circular separator, and a circular second electrode, step S200 of disposing a first contact member on the electrode assembly and bending and disposing a first electrode tab connected to the first electrode on the first contact member, step S300 of accommodating the electrode assembly in an accommodation can with one opened side, and step S400 of sealing the one opened side of the accommodation can with a cap assembly and connecting the first electrode tab and the accommodation can by a pressure transmitted from the cap assembly.

In an implementation, in step S100, an electrode assembly 100 may be formed by alternately stacking a first electrode 110, a separator 130, and a second electrode 120.

According to one embodiment, the step of forming the electrode assembly 100 may include a step of forming the first electrode 110 and the second electrode 120. The first electrode 110 may be formed to include a first coated portion formed on an inner side of a string 150 (see FIG. 6) set on an outer periphery of a circular base member of the first electrode 110 and coated with a first active material, and a first uncoated portion formed on an outer side of the string 150 and not coated with the first active material. The second electrode 120 may be formed to include a second coated portion formed on the inner side of the string 150 set on the outer periphery of the circular base member of the second electrode 120 and coated with a second active material, and a second uncoated portion formed on the outer side of the string 150 and not coated with the second active material.

According to one embodiment, the first electrode tab 113 may be connected to the first electrode 110. The second electrode tab 123 may be connected to the second electrode 120.

In step S200, a first contact member 210 may be disposed on the electrode assembly 100. The first electrode tab 113 connected to the first electrode 110 may be bent and disposed on the first contact member 210. In other embodiments, a second contact member 220 may be disposed on the other side of the electrode assembly 100 on which the first contact member 210 is disposed. The second electrode tab 123 connected to the second electrode 120 may be bent and disposed on the second contact member 220.

In step S300, the electrode assembly 100 may be accommodated in an accommodation can 300 with one opened side. The first electrode tab 113 may be disposed between the electrode assembly 100 and one side surface inside the accommodation can 300. The accommodation can 300 may be connected to the first electrode tab 113. The accommodation can 300 may be connected to the first electrode 110 through the first electrode tab 113 and may function as a negative electrode.

In step S400, the second electrode tab 123 and the cap assembly 400 may be connected while sealing the one opened side of the accommodation can 300 with the cap assembly 400. The cap assembly 400 may function as a positive electrode by being connected to the second electrode 120 through the second electrode tab 123.

The first contact member 210 may be pressed between the electrode assembly 100 and the accommodation can 300 by a pressure transmitted from the cap assembly 400, and thus, the first electrode tab 113 and the accommodation can 300 may be brought into close contact with each other. The second contact member 220 may be pressed between the cap assembly 400 and the electrode assembly 100 by the pressure transmitted from the electrode assembly 100 or the cap assembly 400, and thus, the second electrode tab 123 and the cap assembly 400 are brought into close contact with each other.

The secondary battery 1 formed in this manner may connect the electrode tabs 113 and 123, the accommodation can 300, and the cap assembly 400 by disposing the elastic contact members 210 and 220) between the electrode assembly 100 and the accommodation can 300 and/or between the electrode assembly 100 and the cap assembly 400.

According to some embodiments of the present disclosure, the elastic contact members 210 and 220 may be disposed between the electrode assembly 100 and the accommodation can 300 and/or between the electrode assembly 100 and the cap assembly 400, and thus, damage to an internal structure of the secondary battery 1 due to external impact, such as vibration or dropping, may be prevented.

By way of summation and review, a secondary battery may include an electrode assembly including a positive electrode and a negative electrode, a can for accommodating the electrode assembly, and electrode terminals connected to the electrode assembly. The electrode assembly may be accommodated in the can in a winding type or stack type structure. If a winding type electrode assembly is used for the coin cell or button cell, the capacity may be limited due to a problem such as deformation or cracking caused by electrode expansion. To solve the problem of such a winding type electrode assembly, a stack type electrode assembly that controls the continuity of expansion by using an assembly of discontinuous electrodes may be used. However, in the case of the stack type electrode assembly, a sufficient internal space may be required between the electrode assembly, the can, and cap assembly to ensure stable current conduction and insulation, and thus, a loss in capacity may be caused.

According to some embodiments of the present disclosure, in order to manufacture a circular stack type electrode assembly, a circular electrode plate structure capable of stably connecting electrode tabs and increasing regions for applying an active material may be provided.

According to some embodiments of the present disclosure, an elastic contact member may be between the electrode assembly and the accommodation can and/or between the electrode assembly and the cap assembly, and thus, the electrode tabs, the accommodation can, and the cap assembly may be connected without separate welding.

According to some embodiments of the present disclosure, an elastic contact member may be between the electrode assembly and the accommodation can and/or between the electrode assembly and the cap assembly, and thus, damage to an internal configuration of the secondary battery due to external impact, such as vibration or dropping, may be prevented.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

However, aspects and features of the present disclosure are not limited to those described above, and other aspects and features not mentioned will be clearly understood by a person skilled in the art from the detailed description, described above.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
an electrode assembly including:
an electrode stacked body including a circular first electrode, a circular separator, and a circular second electrode in an alternating arrangement,
a first electrode tab connected to the first electrode, and
a second electrode tab connected to the second electrode;
an accommodation can accommodating the electrode assembly, the accommodation can electrically connected to the first electrode tab;
a cap assembly sealing an opening of the accommodation can, the cap assembly electrically connected to the second electrode tab; and
a first contact member between the electrode assembly and the first electrode tab.

2. The secondary battery as claimed in claim 1, wherein:
the first electrode includes:
a first string on and extending across an outer periphery of a circular base member of the first electrode, the first string dividing the circular base member of the first electrode into a first inner portion and a first outer portion,
a first coated portion on the first inner portion, the first coated portion being coated with a first active material, and
a first uncoated portion on the first outer portion, the first uncoated portion being not coated with the first active material,
the second electrode includes:
a second string on and extending across an outer periphery of a circular base member of the second electrode, the second string dividing the circular base member of the second electrode into a second inner portion and a second outer portion,
a second coated portion on the second inner portion, the second coated portion being coated with a second active material, and
a second uncoated portion on the second outer portion, the second uncoated portion being not coated with the second active material.

3. The secondary battery as claimed in claim 2, wherein:
an angle between a center of the circular base member of the first electrode and ends of the first string is 30° to 60°, and
an angle between a center of the circular base member of the second electrode and ends of the second string is 30° to 60°.

4. The secondary battery as claimed in claim 2, wherein an area of the first uncoated portion and an area of the second uncoated portion are each, respectively, 0.4% to 2.9% of a total area of the circular base member of the first electrode and a total area of the circular base member of the second electrode.

5. The secondary battery according to claim 2, wherein:
a radius of the second electrode is less than a radius of the first electrode, and
the second electrode tab includes an insulating layer connected to one side of the second electrode in a region of the second electrode facing the first electrode.

6. The secondary battery as claimed in claim 1, wherein:
the first electrode tab is bent and between a lower surface of the electrode assembly and a bottom surface of the accommodation can, and
the first contact member is between the lower surface of the electrode assembly and the bent first electrode tab.

7. The secondary battery as claimed in claim 1, wherein when the cap assembly and the accommodation can are coupled, the first electrode tab is in close contact with a side surface inside the accommodation can.

8. The secondary battery as claimed in claim 1, wherein the first contact member includes an elastic insulator.

9. The secondary battery as claimed in claim 8, wherein the first contact member includes an elastic porous material.

10. The secondary battery as claimed in claim 1, further comprising a second contact member between the electrode assembly and the second electrode tab.

11. The secondary battery as claimed in claim 10, wherein:
the second electrode tab is bent and between an upper surface of the electrode assembly and the cap assembly, and
the second contact member is between the upper surface of the electrode assembly and the bent second electrode tab.

12. The secondary battery as claimed in claim 10, wherein when the cap assembly and the accommodation can are coupled, the second electrode tab is in close contact with a side surface inside the cap assembly.

13. The secondary battery as claimed in claim 10, wherein the second contact member includes an elastic insulator.

14. The secondary battery as claimed in claim 13, wherein the second contact member includes an elastic porous material.

15. The secondary battery as claimed in claim 1, wherein the cap assembly includes:
a terminal plate connected to the second electrode tab,
a cap plate having a first opening portion joined to the opening of the accommodation can, and
a cap insulating layer having a second opening portion and located between the terminal plate and the cap plate insulating the terminal plate and the cap plate.

16. The secondary battery as claimed in claim 15, wherein the terminal plate includes:
a body portion connected to the second electrode tab, and
a protrusion extending upward from a center of the body portion and penetrating the first opening portion.

17. The secondary battery as claimed in claim 16, wherein a diameter of the body portion is greater than a diameter of an outer peripheral surface of the electrode assembly.

18. The secondary battery as claimed in claim 1, further comprising an insulating member on a side surface inside the accommodation can corresponding to the second electrode tab.

19. A method for manufacturing a secondary battery, the method comprising:
forming an electrode assembly by alternately stacking a circular first electrode, a circular separator, and a circular second electrode;
disposing a first contact member on the electrode assembly, and bending and disposing a first electrode tab connected to the first electrode on the first contact member;
accommodating the electrode assembly in an accommodation can with one opened side; and
sealing the one opened side of the accommodation can with a cap assembly and connecting the first electrode tab and the accommodation can by a pressure transmitted from the cap assembly.

20. The method for manufacturing a secondary battery as claimed in claim 19, wherein the forming of the electrode assembly includes:
forming a first electrode including a first coated portion formed on an inner side of a first string set on and extending across an outer periphery of a circular base member of the first electrode and coated with a first active material and a first uncoated portion on an outer side of the string not coated with the first active material, and
forming a second electrode including a second coated portion formed on an inner side of a second string set on and extending across an outer periphery of a circular base member of the second electrode and coated with a second active material and a second uncoated portion formed on an outer side of the second string not coated the second active material.
